(19) United States
(12) Patent Application Publication
(10) Pub. No.: US 2026/0115940 A1
(43) Pub. Date: Apr. 30, 2026

(54) SUBSTRATE PROCESSING APPARATUS AND POWER TRANSMISSION METHOD IN VACUUM CHAMBER

(71) Applicant: SEMES CO., LTD., Cheonan-si (KR)

(72) Inventors: Jae Won CHOI, Osan-si (KR); Kyo Bong KIM, Seongnam-si (KR); Hee Jae BYUN, Yongin-si (KR); Sang Oh KIM, Seoul (KR)

(73) Assignee: SEMES CO., LTD., Cheonan-si (KR)

(21) Appl. No.: 19/373,001

(22) Filed: Oct. 29, 2025

(30) Foreign Application Priority Data
Oct. 30, 2024 (KR) 10-2024-0151211

(51) Int. Cl. B25J 19/00; B25J 11/00; B25J 21/00; H01R 13/73

(52) U.S. Cl. CPC B25J 19/0045; B25J 11/0095; B25J 21/005; H01R 13/73

(57) ABSTRACT

Provided is an apparatus for processing a substrate, the apparatus including: at least one transfer chamber; and a transfer robot which is linearly movable within the transfer chamber and transfers a substrate, in which the transfer robot includes a power receiving unit that receives power, the transfer chamber includes: a chamber base; and a power feeding unit provided on the chamber base and wirelessly transmitting power to the power receiving unit, and the power feeding unit includes: a plurality of power feeding cables; a plurality of terminal units connected to the plurality of power feeding cables; and at least one connection member connected to at least one of the plurality of terminal units so as to switch a direction of a current flowing in the power feeding cable at least twice or more times.

### CROSS-REFERENCE TO RELATED APPLICATION

This application claims priority to and the benefit of Korean Patent Application No. 10-2024-0151211 filed in the Korean Intellectual Property Office on Oct. 30, 2024, the entire contents of which are incorporated herein by reference.

### TECHNICAL FIELD

The present invention relates to a substrate processing apparatus and a power transmission method in a vacuum chamber.

### BACKGROUND ART

The semiconductor manufacturing process is performed through various steps, and among them, a highly precise fine process is required. Among these fine processes, the process using plasma plays an important role in semiconductor manufacturing. The plasma process electrically ionizes the reactive/deposition gas to generate a plasma state containing ions, electrons, neutral particles, and the like in a high energy state, and performs various functions, such as forming a desired pattern on the wafer or removing impurities using the plasma. In some cases, the plasma process may perform a function of depositing a film on a wafer.

In order to perform the plasma process, the semiconductor manufacturing equipment includes a process chamber that generates plasma to process the wafer. The inside of the chamber is designed to convert reactive/deposited gas into a plasma state, and the process is performed in a highly controlled vacuum state so that plasma is uniformly distributed on the wafer surface. The plasma process includes several steps, such as etching and deposition, and is an essential technology for forming a fine structure of a semiconductor device.

Meanwhile, a process of transferring a substrate, such as a wafer, from semiconductor manufacturing equipment is also very important. The plasma process chamber and the transfer chamber for transferring the substrate are connected to each other, and the transfer chamber must also be adjusted to a vacuum atmosphere VE identical or similar to the process chamber. This is an essential condition for preventing the inflow of external air and maintaining a high-level clean state required by the plasma process. The vacuum state in the transfer chamber ensures that the substrate may move smoothly to the plasma process chamber and minimizes contamination or damage affecting to the substrate during the process.

Therefore, vacuum maintenance between the transfer chamber and the plasma process chamber, reliability of substrate transfer, and power transmission efficiency in the process are considered as very important factors in order to perform the plasma process stably in the semiconductor manufacturing process.

### SUMMARY OF THE INVENTION

The present invention has been made in an effort to provide a substrate processing apparatus and a power transmission method capable of transmitting power to a transfer robot with high efficiency.

The present invention has also been made in an effort to provide a substrate processing apparatus and a power transmission method capable of minimizing heat generation when transmitting power to a transfer robot.

The present invention has also been made in an effort to provide a substrate processing apparatus and a power transmission method capable of extending a transfer chamber.

The objectives of the present disclosure are not limited thereto and other objectives not stated herein may be clearly understood by those skilled in the art from the following description.

An exemplary embodiment of the present disclosure, an apparatus for processing a substrate, the apparatus comprising: at least one transfer chamber; and a transfer robot which is linearly movable within the transfer chamber and transfers a substrate, wherein the transfer robot includes a power receiving unit that receives power, the transfer chamber includes: a chamber base; and a power feeding unit provided on the chamber base and wirelessly transmitting power to the power receiving unit, and the power feeding unit may includes: a plurality of power feeding cables; a plurality of terminal units connected to the plurality of power feeding cables; and at least one connection member connected to at least one of the plurality of terminal units so as to switch a direction of a current flowing in the power feeding cable at least twice or more times.

An exemplary embodiment of the present disclosure, a method of transmitting power to a robot that linearly moves in a vacuum chamber, the method may comprising, connecting supply cables to only a part of a plurality of terminals of a front terminal unit; flowing a current to power feeding cables of a first group among a plurality of power feeding cables provided between the front terminal unit and a rear terminal unit by supplying, by the supply cable, the current; when the current flows into the rear terminal unit, primarily returning, by a first connection member, the current from the rear terminal unit to the front terminal unit using power feeding cables of a second group among the plurality of power feeding cables; and when the primarily returned current flows into the front terminal unit, secondarily returning, by a second connection member, the current from the front terminal unit to the rear terminal unit using power feeding cables of a third group among the plurality of power feeding cables.

An exemplary embodiment of the present disclosure, an apparatus for processing a substrate, the apparatus comprising: at least one transfer chamber; and a process chamber; and a transfer robot which is linearly movable within the transfer chamber and transfers a substrate to the transfer chamber, wherein the transfer robot includes a power receiving unit that receives power, the transfer chamber includes: a chamber base; and a power feeding unit provided in the chamber base, the power feeding unit includes: a plurality of power feeding cables; a plurality of terminal units connected to one end and the other end of the plurality of power feeding cables, the plurality of terminal units includes: a front terminal unit connected with a power supply device; and a rear terminal unit electrically farther from the power supply device than the front terminal unit, the front terminal unit includes: a first front terminal unit electrically adjacent to the power supply device; and a second front terminal unit electrically farther from the power supply device than the first front terminal unit, the first front terminal unit and the second front terminal unit include the plurality of terminals, and the terminals included in the first front terminal unit and the terminals included in the second front terminal unit are provided in pairs to be electrically connected to each other, and supply cables for supplying the current of the power supply device are connected to a part of the plurality of terminals of the first front terminal unit, and second connection members for returning the current flowing-in from the rear terminal unit into the front terminal unit may be connected to another part.

According to the exemplary embodiment of the present invention, it is possible to transmit power to a transfer robot with high efficiency.

In addition, according to the exemplary embodiment of the present invention, it is possible to minimize heat generation when transmitting power to a transfer robot.

In addition, according to the exemplary embodiment of the present invention, it is possible to extend a transfer chamber.

Effects of the present disclosure are not limited to those described above and effects not stated above will be clearly understood to those skilled in the art from the specification and the accompanying drawings.

### BRIEF DESCRIPTION OF THE DRAWINGS

FIG. 1 is a top plan view schematically illustrating a substrate processing apparatus according to an exemplary embodiment of the present invention.

FIG. 2 is a diagram schematically illustrating a power transmission structure for transmitting power to a transfer robot of FIG. 1.

FIG. 3 is a view schematically illustrating a structure in which a power supply device positioned outside the transfer chamber supplies power with a power feeding cable of FIG. 2.

FIG. 4 is a diagram schematically illustrating a structure in which the power supply device of FIG. 3 circulates a current to the power feeding cable.

FIG. 5 is a top plan view schematically illustrating a substrate processing apparatus according to another exemplary embodiment of the present invention.

FIG. 6 is a diagram schematically illustrating a structure in which a power supply device circulates a current through a power feeding cable in another exemplary embodiment of FIG. 5.

FIG. 7 is a top plan view schematically illustrating a substrate processing apparatus according to another exemplary embodiment of the present invention.

FIG. 8 is a diagram illustrating a method of extending a power supply line using a base plate.

FIG. 9 is a diagram illustrating an end of the base plate of FIG. 8.

FIG. 10 is a diagram illustrating a communication method between an external controller located outside a transfer chamber of FIG. 1 and a robot controller located inside the transfer chamber.

FIG. 11 is a diagram illustrating a heat dissipation method for discharging heat generated by an active device located in the transfer robot of FIG. 1 to the outside.

FIGS. 12 and 13 are diagrams illustrating a method of transferring a substrate to a process chamber by the transfer robot of FIG. 1.

The various features and advantages of the non-limiting exemplary embodiment of the present specification may become more apparent by reviewing the detailed description together with the accompanying drawings. The accompanying drawings are provided for illustrative purposes only and should not be construed as limiting the scope of claims. The accompanying drawings are not considered to be drawn to scale unless explicitly stated. For clarity, the various dimensions of the drawings may have been exaggerated.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When the term “same” or “identical” is used in the description of example embodiments, it should be understood that some imprecisions may exist. Thus, when one element or value is referred to as being the same as another element or value, it should be understood that the element or value is the same as the other element or value within a manufacturing or operational tolerance range (e.g., ±10%).

When the terms “about” or “substantially” are used in connection with a numerical value, it should be understood that the associated numerical value includes a manufacturing or operational tolerance (e.g., ±10%) around the stated numerical value. Moreover, when the words “generally” and “substantially” are used in connection with a geometric shape, it should be understood that the precision of the geometric shape is not required but that latitude for the shape is within the scope of the disclosure.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

In the following description, the present invention will be described based on the case where a substrate processing apparatus 10 processes a substrate W, such as a wafer, as an example. In addition, in the following description, the present invention will be described based on the case where the substrate processing apparatus 10 is semiconductor manufacturing equipment that performs at least some of several processes performed for manufacturing a semiconductor device. In addition, in the following description, the present invention will be described based on the case where the substrate processing apparatus 10 is the substrate processing apparatus 10 that processes a substrate W using plasma as an example. In addition, in the following description, the present invention will be described based on the case where the substrate processing apparatus 10 is an apparatus that performs an etching or ashing process to remove a film on the substrate W, or a device that performs a deposition process to form a film on the substrate W using plasma.

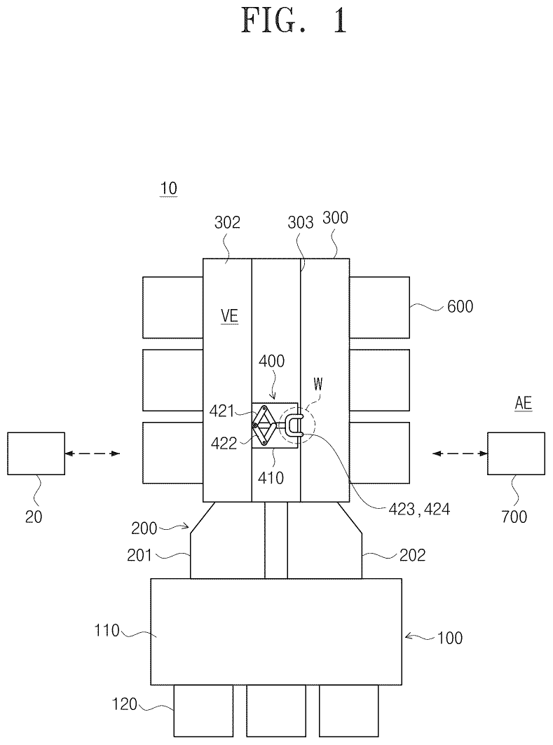

FIG. 1 is a top plan view schematically illustrating a substrate processing apparatus according to an exemplary embodiment of the present invention.

Referring to FIG. 1, a substrate processing apparatus 10 according to an exemplary embodiment of the present invention may include a front end module 100, a load lock chamber 200, a transfer chamber 300, a transfer robot 400, a feedthrough 500, a process chamber 600, and an external controller 700.

The front end module 100 may function as a loading/unloading module for loading an unprocessed substrate W or unloading the processed substrate W. The front end module 100 may include an index chamber 110 and a load port 120.

The index chamber 110 may be provided with a transfer robot which is not illustrated. The transfer robot provided to the index chamber 110 may unload the substrate W from a container placed on the load port 120 and transfer the substrate W to the load lock chamber 200 to be described later, or unload the substrate W from the load lock chamber 200 and transfer the substrate W to the container placed on the load port 120.

The atmosphere in the index chamber 110 may be controlled to be a first atmosphere which is the same as or similar to the external environment of the substrate processing apparatus 10. For example, the first atmosphere may be an atmospheric pressure atmosphere AE. The atmospheric pressure atmosphere AE may mean a pressure state. Accordingly, the pressure state in the index chamber 110 may be the same as or similar to the external environment, but a cleanliness state (e.g., a particle level) in the index chamber 110 may be maintained in a better state than the external environment.

Additionally, the index chamber 110 may be equipped with a fan filter unit that is capable of supplying Clean Dry Air (CDA) or nitrogen gas so that the atmosphere in the index chamber 110 may be maintained in the first atmosphere.

A plurality of load ports 120 may be provided. A plurality of load ports 120 may be disposed side by side on one side of the index chamber 110. Specifically, the load port 120 may be connected to the index chamber 110 on an opposite side of the load lock chamber 200 to be described later. The container in which the substrate W is accommodated is seated on the load port 120. The container may be a container called a Front-Opening Unified Pod (FOUP), a Front-Opening Shipping Box (FOSB), a Standard Mechanical Interface (SMIF) pod, or a container called a cassette. A plurality of substrates W may be accommodated in each container.

The container may be transferred to the front end module 100 or unloaded from the front end module 100 by an Over Head Transport Apparatus (OHT) installed on the ceiling of the semiconductor manufacturing line, an Automated Guided Vehicle (AGV) travelling along a floor of a semiconductor manufacturing line, an Autonomous Mobile Robot (AMR), or the like.

The load lock chamber 200 may be disposed between the front end module 100 and the transfer chamber 300. The atmosphere in the load lock chamber 200 may be changed between the first atmosphere and a second atmosphere. As described above, the first atmosphere may be the atmospheric pressure atmosphere AE. The second atmosphere may be a vacuum atmosphere VE. Here, the vacuum atmosphere VE may refer to a pressure state. The vacuum atmosphere VE may be an atmosphere in which a pressure state is significantly lower than that of the atmospheric pressure atmosphere AE.

The load lock chamber 200 may include a gas nozzle capable of supplying inert gas, such as CDA or nitrogen gas, into the chamber, and at least one exhaust hole formed to exhaust the inside of the chamber so as to switch the internal atmosphere between the first and second atmospheres AE and VE.

When the transfer robot (not illustrated) provided to the front end module 100 and/or the transfer robot 400 provided to the transfer chamber 300 loads the substrate W into the load lock chamber 200 or unload the substrate W from the load lock chamber 200, the atmosphere in the load lock chamber 200 may be changed.

For example, when the substrate W is loaded into the load lock chamber 200 from the front end module 100 in the first atmosphere, which is the atmospheric pressure atmosphere AE, the atmosphere in the load lock chamber 200 is maintained in the first atmosphere before the substrate W is loaded into the load lock chamber 200, and when the substrate W is completely loaded into the load lock chamber 200, the atmosphere in the load lock chamber 200 is changed from the first atmosphere, which is the atmospheric pressure atmosphere AE, to the second atmosphere, which is the vacuum atmosphere VE, and when the atmosphere in the load lock chamber 200 is changed to the second atmosphere, the door of the load lock chamber 200 is opened, and then the transfer robot 400 provided to the transfer chamber 300 may unload the substrate W from the load lock chamber 200. In this case, the atmosphere in the transfer chamber 300 may be maintained in the second atmosphere, which is the vacuum atmosphere VE, as described later.

In short, the load lock chamber 200 may function as an atmosphere switching module that changes the atmosphere when the load lock chamber 200 is disposed between the front end module 100 maintained in the atmospheric pressure atmosphere AE and the transfer chamber 300 maintained in the vacuum atmosphere VE and the substrate W is transferred between the spaces having the different atmospheres.

The load lock chamber 200 may have a first load lock chamber 201 and a second load lock chamber 202. The first load lock chamber 201 may provide a part of a first transfer path through which the unprocessed substrate W requiring processing in the process chamber 600 is transferred. The second load lock chamber 202 may provide a part of a second transfer path through which the processed substrate W that has been processed in the process chamber 600 is transferred. This is because higher cleanliness is maintained for the processed substrate W than for the unprocessed substrate W. In other words, the substrate processing apparatus 10 may increase the cleanliness maintenance efficiency for the processed substrate W by providing different transfer paths to the unprocessed substrate W and the processed substrate W.

The transfer chamber 300 may provide a space in which the transfer robot 400 is provided. The internal atmosphere of the transfer chamber 300 may be maintained in the second atmosphere. The second atmosphere may be the vacuum atmosphere VE. In order to maintain the atmosphere in the transfer chamber 300 in the vacuum atmosphere VE, at least one exhaust hole connected to a pump that provides pressure reduction and the like may be formed in the transfer chamber 300. Since the exhaust device, such as the pump, exhausts the exhaust hole, the internal atmosphere of the transfer chamber 300 may be maintained in the second atmosphere.

When the internal atmosphere of the transfer chamber 300 becomes the second atmosphere, impurities, such as particles, that may be provided in the transfer chamber 300 may be discharged to the outside of the transfer chamber 300. In addition, as described later, the atmosphere of the process chamber 600 may be controlled to the second atmosphere. By controlling the atmospheres of the transfer chamber 300 and the process chamber 600 identically or similarly to the second atmosphere, it is possible to minimize the generation of impurities, such as particles, due to the difference in pressure when the transfer chamber 300 and the process chamber 600 communicate with each other.

The transfer chamber 300 may include a chamber base 302 which is a bottom surface of the space in the chamber, and a travelling rail 303 installed on the chamber base 302. The transfer robot 400, which will be described later, may be linearly moved along the travelling rail 303 of the transfer chamber 300.

The transfer robot 400 may be provided in the transfer chamber 300. The transfer robot 400 may transfer the substrate W. The transfer robot 400 may be linearly moved in the transfer chamber 300. Also, the transfer robot 400 may include a plurality of arms. For example, a plurality of arms may include a first arm 421 having a first end effector 423 and a second arm 422 having a second end effector 424 to be described below. The first and second arms 421 and 422 may be elongated and contracted. As the transfer robot 400 is linearly moved in the transfer chamber 300 and the first and second arms 421 and 422 are elongated and contracted, the substrate W may be loaded into or unloaded from the process chamber 600.

The feedthrough 500 may be positioned between the substrate processing apparatus 10 and the power supply device 20 disposed outside. The feedthrough 500 may serve as a medium for electrically connecting the outside of the transfer chamber 300 in the atmospheric pressure atmosphere AE and the inside of the transfer chamber 300 in the vacuum atmosphere VE. The power supply device 20 may be electrically connected to the feedthrough 500, and the feedthrough 500 may be electrically connected to a power feeding unit 310 to be described later. The structure and method of supplying power to the transfer robot 400 through the power supply device 20 will be described later.

The process chamber 600 may process the substrate W. The process chamber 600 may perform at least one of processes required to manufacture a semiconductor device. For example, the process chamber 600 may be configured to perform a plasma process of processing the substrate W using plasma. The process chamber 600 may perform processes, such as etching or ashing, of removing a film formed on the substrate W using plasma. In contrast, the process chamber 600 may perform processes, such as deposition and passivation, of forming a film on the substrate W using plasma.

The atmosphere in the process chamber 600 may be controlled by the second atmosphere, which is the vacuum atmosphere VE. The vacuum atmosphere VE may be an atmosphere having a pressure state significantly lower than that of the atmospheric pressure atmosphere AE. The atmosphere of the process chamber 600 and the atmosphere of the transfer chamber 300 may be controlled identically to the second atmosphere. The fact that the atmosphere of the process chamber 600 and the atmosphere of the transfer chamber 300 are the same should be understood as a concept including not only the case where the pressures are completely the same, but also the case where the atmospheres of the two chambers 300 and 600 are maintained in an atmosphere close to vacuum even though there is a slight difference in pressure.

In addition, the process chamber 600 may have various configurations for performing the above-described plasma process. For example, the process chamber 600 may include configurations, such as a plasma source composed of opposite electrodes, antennas, and RF power sources, a gas supply unit that supplies reactive gas or deposition gas into the process chamber 600, an exhaust hole for exhausting the atmosphere in the process chamber 600, the exhaust hole being connected to an exhaust device such as a vacuum pump, a support unit supporting the substrate W, and a temperature control means, such as a heater and a cooler, for controlling the temperature of the substrate W. The configurations of the process chamber 600 are not limited to these, and may be variously modified into known configurations of the process chamber performing the plasma process.

The external controller 700 may be disposed outside the transfer chamber 300. The external controller 700 may generate a control signal for controlling the above-described configurations of the substrate processing apparatus 10. The external controller 700 may be disposed outside the transfer chamber 300, that is, in a space having the first atmosphere, which is the atmospheric pressure atmosphere AE. The external controller 700 controls the substrate processing apparatus 10. The external controller 700 may include a process controller formed of a microprocessor (computer) that executes the control of the substrate processing apparatus 10, a user interface including a keyboard in which an operator performs a command input operation or the like in order to manage the substrate processing apparatus 10, a display for visualizing and displaying an operation situation of the substrate processing apparatus 10, and the like, and a storage unit storing a control program for executing the process executed in the substrate processing apparatus 1 under the control of the process controller or a program, that is, a treating recipe, for executing the process in each component according to various data and treating conditions. Further, the user interface and the storage unit may be connected to the process controller. The processing recipe may be stored in a storage medium in the storage unit, and the storage medium may be a hard disk, and may also be a portable disk, such as a CD-ROM or a DVD, or a semiconductor memory, such as a flash memory.

Hereinafter, a system and method for transmitting power from the external power supply device 20 to the transfer robot 400 will be described in detail.

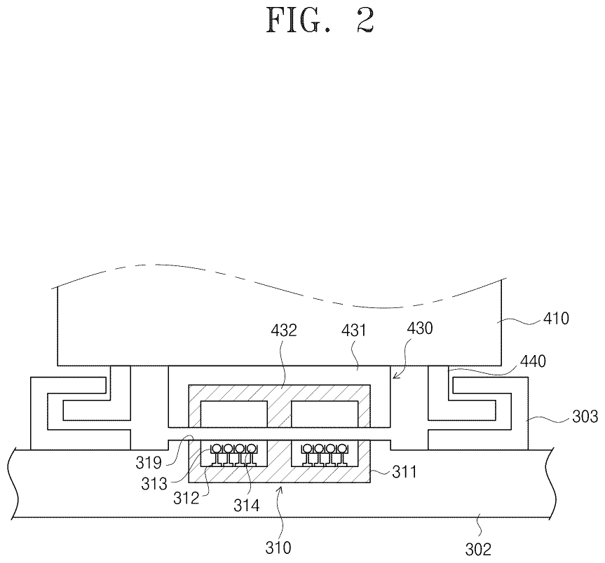

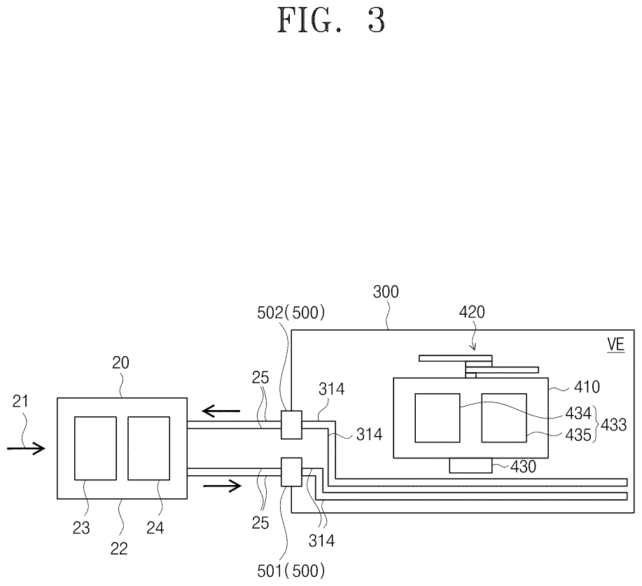

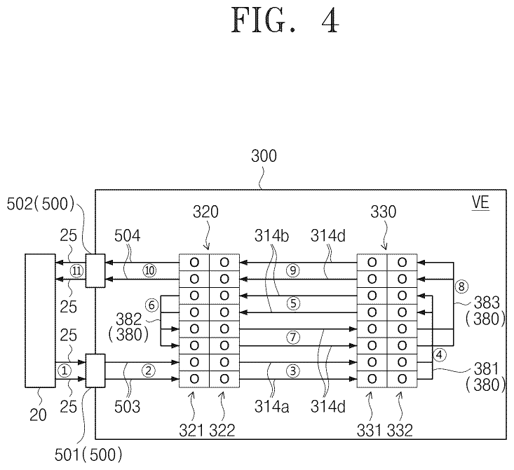

FIG. 2 is a diagram schematically illustrating a power transmission structure for transmitting power to the transfer robot of FIG. 1. FIG. 3 is a view schematically illustrating a structure in which the power supply device positioned outside the transfer chamber supplies power with a power feeding cable of FIG. 2, and FIG. 4 is a diagram schematically illustrating a structure in which the power supply device of FIG. 3 circulates a current to the power feeding cable.

Referring to FIGS. 2 to 4, the power transmission system may be composed of the power supply device 20, the power feeding unit 310 of the transfer chamber 300, and the transfer robot 400.

The power supply device 20 may include a power source 21 and a primary-side converter unit 22 connected to the power source 21. The primary-side converter unit 22 may include a primary-side converter 23 and a primary-side resonance circuit 24. The primary-side converter 23 may be an AC-DC or DC-AC converter. The primary-side resonance circuit 24 may have a circuit structure capable of improving power supply efficiency by implementing impedance matching.

The transfer chamber 300 may have a chamber base 302, a travelling rail 303, and the power feeding unit 310. The travelling rail 303 and the power feeding unit 310 may be provided on the chamber base 302. The power feeding unit 310 may be fixedly provided to the chamber base 302 of the transfer chamber 300. The power feeding unit 310 may be referred to as a fixed power supply member.

The power feeding unit 310 provided in the transfer chamber 300 may include a first ferrite core 311, a support member 312, a support bracket 313, a power feeding cable 314, and a plurality of terminal units 320 and 330. A plurality of terminal units 320 and 330 may include a first terminal unit 320 and a second terminal unit 330. Among them, the first terminal unit 320 may be provided as a front terminal unit electrically adjacent to the power supply device 20. Also, the second terminal unit 330 may be provided as a rear terminal unit electrically farther from the power supply device 20 than the first terminal unit 320. The first and second terminal units 320 and 330 may be electrically connected to each other by the power feeding cable 314.

The first ferrite core 311 may be disposed on the chamber base 302 provided by the transfer chamber 300. The chamber base 302 may be a portion defining a bottom surface of the internal space provided by the transfer chamber 300. A recess in which the first ferrite core 311 may be disposed may be formed in the chamber base 302. The recess may be formed downward from an upper surface of the chamber base 302. The first ferrite core 311 may have an E shape.

The support member 312 and the support bracket 313 may be provided on the first ferrite core 311. The support member 312 and the support bracket 313 may all be made of an insulating material. The support member 312 and the support bracket 313 may block the physical and electrical contact between the power feeding cable 314 and the first ferrite core 311. The support bracket 313 may be provided to be detachable from the support member 312. The support bracket 313 may be replaced with the support bracket 313 having a different shape. The shape of the support bracket 313 may be variously modified depending on the number or shape of the power feeding cable 314 of the power feeding unit 310.

The power feeding cables 314 may be placed on the support bracket 313. The power feeding cables 314 may be disposed in two spaces formed by the E-shaped first ferrite core 311, respectively. The power feeding cable 314 may be disposed at a height lower than an upper end of the first ferrite core 311. The upper portion of the power feeding cable 314 may be covered with a cover 319 having a plate shape.

The current supplied by the power supply device 20 described above may flow through the power feeding cable 314. The current flowing through the power feeding cable 314 may form an electromagnetic field. The electromagnetic field formed by the current flowing through the power feeding cable 314 may be induced to the first ferrite core 311 having an E-shape. The electromagnetic field induced to the first ferrite core 311 may cause inductive coupling to the second ferrite core 432 to be described later. With such inductive coupling, the power feeding unit 310 may transmit power to a power receiving unit 430 in a wireless manner (a non-contact method).

Referring to FIG. 4, the power feeding unit 310 may include the first terminal unit 320 and the second terminal unit 330 as described above. The first terminal unit 320 may be a front terminal unit. The second terminal unit 330 may be a rear terminal unit.

The first terminal unit 320 may include a first terminal unit 321 and a second terminal unit 322. The first terminal unit 321 may include a plurality of terminals. The second terminal unit 322 may include a plurality of terminals. The first terminal unit 321 may be connected with a supply cable 503, a return cable 504, and a connection member 380 to be described later. The second terminal unit 322 may be connected with the above-described feeding cable 314.

The terminals of the first terminal unit 321 and the terminals of the second terminal unit 322 form a plurality of pairs, and the paired terminals may be electrically connected to each other. For example, the terminals of the second terminal unit 322 parallel to any one of the terminals of the first terminal unit 321 may be electrically connected to each other. In addition, the terminals of the second terminal unit 322 parallel to another terminal of the first terminal unit 321 may be electrically connected to each other. The first terminal unit 321 may be referred to as a first front terminal unit, or may be referred to as a first outer terminal unit, if necessary. The second terminal unit 322 may be referred to as a second front terminal unit, or may be referred to as a first inner terminal unit, if necessary.

Hereinafter, in order to clearly explain the connection structure of the power feeding cables 314 and the connection members 380, the terminals of each terminal unit 321, 322 are referred to as terminal No. 1, terminal No. 2, . . . , terminal No. 8 in order.

For example, the terminal connected to one of the supply cables 503 among the terminals of the first terminal unit 321 is referred to as terminal No. 1 of the first terminal unit 321, and the terminal connected to another supply cable 503 is referred to as terminal No. 2 of the first terminal unit 321, and so on. In addition, the terminal provided in pair with terminal No. 1 of the first terminal unit 321 among the terminals of the second terminal unit 322 is referred to as terminal No. 1 of the second terminal unit 322, the terminal provided in pair with terminal No. 2 of the first terminal unit 321 among the terminals of the second terminal unit 322 is referred to as terminal No. 2 of the second terminal unit 322, and so on.

The second terminal unit 330 may include a third terminal unit 331 and a fourth terminal unit 332. The third terminal unit 331 may include a plurality of terminals. The fourth terminal unit 332 may include a plurality of terminals. The above-described power feeding cable 314 may be connected to the third terminal unit 331. At least one connection member 380 to be described later may be connected to the fourth terminal unit 332.

The terminals of the third terminal unit 331 and the terminals of the fourth terminal unit 332 form a plurality of pairs, and the paired terminals may be electrically connected to each other. For example, the terminals of the fourth terminal unit 332 parallel to any one of the terminals of the third terminal unit 331 may be electrically connected to each other. In addition, the terminals of the fourth terminal unit 332 parallel to another terminal of the third terminal unit 331 may be electrically connected to each other. The third terminal unit 331 may be referred to as a first rear terminal unit, or may be referred to as a second internal terminal unit, if necessary. The fourth terminal unit 332 may be referred to as a second rear terminal unit, or may be referred to as a second external terminal unit, if necessary.

The first terminal unit 321, the second terminal unit 322, the third terminal unit 331, and the fourth terminal unit 332 may be electrically adjacent to the power supply device 20 in that order.

The connection member 380 may electrically connect terminals of the first and second terminal units 320 and 330. One or more, for example, a plurality of connection members 380 may be provided. The connection member 380 may be a member made of a conductive material. For example, the connection member 380 may be a member made of a metal material through which a current may flow. A plurality of connection members 380 may include a first connection member 381, a second connection member 382, and a third connection member 383.

The first connection member 381 may be configured to return the current flowing into the second terminal unit 330 via the first terminal unit 320 to the first terminal unit 320 again. The first connection member 381 may be connected to the fourth terminal unit 332 of the second terminal unit 330. For example, one end of the first connection member 381 may be connected to terminal No. 1 and terminal No. 2 of the fourth terminal unit 332, and the other end of the first connection member 381 may be connected to terminal No. 5 and terminal No. 6 of the fourth terminal unit 332.

The second connection member 382 may be configured to return the current flowing into the first terminal unit 320 through the second terminal unit 330 to the second terminal unit 330 again. The second connection member 382 may be connected to the first terminal unit 321 of the first terminal unit 320. For example, one end of the second connection member 382 may be connected to terminal No. 5 and terminal No. 6 of the first terminal unit 321, and the other end of the second connection member 382 may be connected to terminal No. 3 and terminal No. 4 of the first terminal unit 321.

The third connection member 383 may be configured to return the current flowing to the second terminal unit 330 via the first terminal unit 320 to the first terminal unit 320 again. The third connection member 383 may be connected to the fourth terminal unit 332 of the second terminal unit 330. For example, one end of the third connection member 383 may be connected to terminal No. 3 and terminal No. 4 of the fourth terminal unit 332, and the other end of the third connection member 383 may be connected to terminal No. 7 and terminal No. 8 of the fourth terminal unit 332.

The first terminal unit 320 and the second terminal unit 330 may be connected to each other by the power feeding cable 314. A plurality of power feeding cables 314 may be provided. The power feeding cables 314 may be divided into a plurality of groups. For example, among the power feeding cables 314, a power feeding cable 314a of a first group may be connected to terminal No. 1 and terminal No. 2 of the second terminal unit 322, and terminal No. 1 and terminal No. 2 of the third terminal unit 331. For example, among the power feeding cables 314, a power feeding cable 314b of a second group may be connected to terminal No. 3 and terminal No. 4 of the second terminal unit 322, and terminal No. 3 and terminal No. 4 of the third terminal unit 331. Among the power feeding cables 314, a power feeding cable 314c of a third group may be connected to terminal No. 5 and terminal No. 6 of the second terminal unit 322, and terminal No. 5 and terminal No. 6 of the third terminal unit 331. Among the power feeding cables 314, a power feeding cable 314d of a fourth group may be connected to terminal No. 7 and terminal No. 8 of the second terminal unit 322, and terminal No. 7 and terminal No. 8 of the third terminal unit 331.

In FIG. 4, the plurality of power feeding cables 314 belonging to each group are illustrated as an example, but the present invention is not limited thereto, and the number of power feeding cables 314 belonging to each group may vary depending on the number of supply cables 503 connecting the supply feedthrough 501 and the first terminal unit 320. For example, when one supply cable 503 is provided, the number of power feeding cables 314 belonging to each group may be provided as one, and when three supply cables 503 are provided, the number of power feeding cables 314 belonging to each group may be provided as three.

The flow of current in the power feeding unit 310 is performed in the following order.
1) The power supply device 20 supplies current to the supply feedthrough 501 through an external cable 25.
2) The current supplied to the supply feedthrough 501 is supplied to the first terminal unit 320.
3) The current supplied to the first terminal unit 320 is supplied to the second terminal unit 330 along the power feeding cable 314a of the first group. In this case, the current flows in a first direction.
4) The current supplied to the second terminal unit 330 is returned to the first terminal unit 320 through the first connection member 381. The direction of the current is switched from the first direction to a second direction by the first connection member 381.
5) The current of which the direction is switched to the second direction by the first connection member 381 is supplied to the first terminal unit 320 along the power feeding cable 314b of the second group. In this case, the current flows in the second direction.
6) The current supplied to the first terminal unit 380 is returned to the second terminal unit 330 through the second connection member 382. The direction of the current is switched from the second direction to the first direction by the second connection member 382.
7) The current of which the direction is switched to the first direction by the second connection member 382 is supplied to the second terminal unit 330 along the power feeding cable 314c of the third group. In this case, the current flows in the first direction.
8) The current supplied to the second terminal unit 330 is returned to the first terminal unit 320 through the third connection member 383. The direction of the current is switched from the first direction to the second direction by the third connection member 383.
9) The current of which the direction is switched to the second direction by the third connection member 383 is supplied to the first terminal unit 320 along the power feeding cable 314d of the fourth group. In this case, the current flows in the second direction.
10) The current supplied to the first terminal unit 320 is supplied to a return feedthrough 502 through the return cable 504.
11) The current supplied to the return feedthrough 502 is returned to the power supply device 20 through the external cable 25.

That is, according to the exemplary embodiment of the present invention, the supply cables 503 are connected to a part of the terminals of the first terminal unit 321 electrically closest to the power supply device 20, the second connection members 382 are connected to another part of the terminals of the first terminal unit 321, and the return cables 504 are connected to another part of the terminals of the first terminal unit 321. For this reason, even when the supply cable 503 is connected to only a small number of terminals, for example, two terminals, the current may flow in a large number of power feeding cables 314, for example, eight power feeding cables 314.

When a current with a large intensity flows through a small number of power feeding cables 314, an electromagnetic field of a large intensity is formed in a narrow range. When a large intensity electromagnetic field is formed in such a narrow range and power is wirelessly transmitted, a high level of heat may be generated in the corresponding power feeding cable 314 and the configurations around the power feeding cable 314. Such heat generation may not only make it difficult to maintain a constant atmosphere in the transfer chamber 300, but may also cause a failure in configurations of the substrate processing apparatus 10.

On the other hand, when a relatively small intensity current flows through a large number of power feeding cables 314, an electromagnetic field of a small intensity is formed in a wide range. And, in a wide range, power transmission by a small intensity electromagnetic field is performed. When a small intensity electromagnetic field is formed in such a wide range and power is wirelessly transmitted, a low level of heat may be generated in the power feeding cable 314 and the configurations around the power feeding cable 314. Therefore, it is possible to minimize the above-described problem that occurs when heat is generated largely.

In the exemplary embodiment of the present invention, even when the supply cable 503 is connected to only two terminals, current flow may occur in the eight power feeding cables 314. That is, the present invention is configured to form an electromagnetic field of a small intensity in a wide range, thereby realizing the above-described technical effect. In addition, in order for the transfer robot 400 to be driven without any problem, the current flow to the power feeding cable 314 needs to be continuously performed. In the present invention, since a relatively small number of supply cables 503 are configured to supply current, power consumption per unit time may be relatively low.

In short, the present invention may reduce power consumption, increase power transmission efficiency, and minimize heat generation in the process of transmitting power.

Referring back to FIGS. 2 to 4, the transfer robot 400 may include an enclosure 410, a robot arm 420, a power receiving unit 430, a secondary-side converter unit 433, a travelling actuator 440, and a robot controller 450.

The enclosure 410 may provide a space therein. The space provided by the enclosure 410 may be an atmosphere different from the second atmosphere of the transfer chamber 300. For example, the atmosphere of the space provided by the enclosure 410 may be the atmospheric pressure atmosphere AE. Various components may be provided inside the enclosure 410. For example, a plurality of motors for driving the robot arm 420 may be provided inside the enclosure 410. Also, the robot controller 450 for receiving a control signal from the external controller 700 may be provided inside the enclosure 410 to operate the robot arm 420. The robot controller 450 may receive a control signal from the external controller 700, and control a plurality of motors for driving the robot arm 420 based on the received control signal and the driving of the travelling actuator 440 to be described later.

The description of the robot arm 420 is the same as described above.

The power receiving unit 430 may be attached to a lower portion of the enclosure 410. The power receiving unit 430 of the transfer robot 400 may wirelessly receive power from the power feeding unit 310 of the transfer chamber 300. The power receiving unit 430 may be referred to as a movable power receiving member.

The power receiving unit 430 may include a housing 431 and a second ferrite core 432 disposed in a space provided by the housing 431. The second ferrite core 432 may be disposed to face the first ferrite core 311 described above. The second ferrite core 432 has an E shape, but has a shape symmetrical to the first ferrite core 311, and may be disposed to face the first ferrite core 311. In the present invention, as the first and second ferrite cores 311 and 432 are provided, power transmission efficiency by inductive coupling may be improved. As power transmission efficiency by the inductive coupling increases, even though a relatively small current flows through the power feeding cable 314, power transmission of the same level becomes possible. Therefore, it is possible to further reduce the problem of heat generation that may occur as a high-intensity current flows through the power feeding cable 314.

The current flowing through the power feeding cable 314 forms an electromagnetic field, and the formed electromagnetic field is inductively coupled by the first and second ferrite cores 311 and 432. Accordingly, the power may be wirelessly transmitted to the power receiving unit 430.

The power transmitted to the power receiving unit 430 may be transferred to the secondary-side converter unit 433 disposed inside the enclosure 410. The secondary-side converter unit 433 may include a secondary-side converter 434 and a secondary-side resonance circuit 435. The secondary-side converter 434 may be an AC-DC or DC-AC converter. The secondary-side resonance circuit 435 may be provided to improve power supply efficiency by implementing impedance matching. The power transferred to the secondary-side converter unit 433 may be transferred to an actuator of the transfer robot 400, for example, a plurality of motors driving the robot arm 420, and/or the travelling actuator 440 to be described below.

The travelling actuator 440 may be moved along the travelling rail 303 provided on the chamber base 302. The travelling actuator 440 and the travelling rail 303 may be configured to allow the transfer robot 400 to linearly move in a magnetic levitation manner.

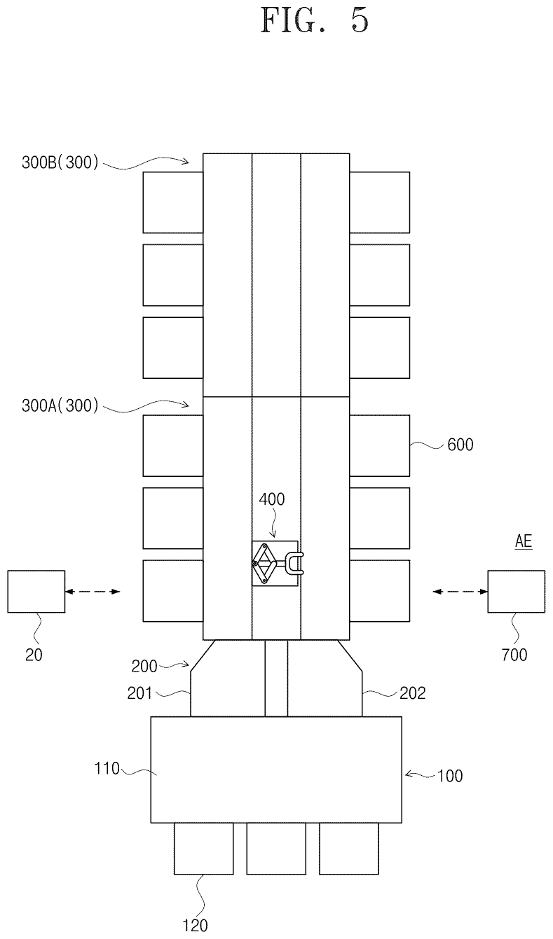

In the above example, the present invention has been described based on the case where one transfer chamber 300 is provided as an example, but the present invention is not limited thereto. For example, as illustrated in FIG. 5, a plurality of transfer chambers 300 may be provided. A plurality of transfer chambers 300 may include a first transfer chamber 300A and a second transfer chamber 300B. The user may selectively connect the second transfer chamber 300B to the first transfer chamber 300A as needed, thereby increasing the number of process chambers 600 connected to one substrate processing apparatus 10. That is, each transfer chamber 300 may be provided in the form of an expandable module.

As illustrated in FIG. 5, when the transfer chamber 300 is expanded, the transfer robot 400 may continuously and linearly move between the first transfer chamber 300A and the second transfer chamber 300B. The first transfer chamber 300A and the second transfer chamber 300B may have the same configurations as those of the transfer chamber 300 described above.

When the second transfer chamber 300B is connected to the first transfer chamber 300A, the travelling rail 303 provided to the first transfer chamber 300A and the travelling rail 303 provided to the second transfer chamber 300B may be continuously connected. Therefore, the transfer robot 400 may freely and linearly move between the first and second transfer chambers 300A and 300B.

Meanwhile, even though the first transfer chamber 300A and the second transfer chamber 300B are connected to each other, the supply of power may have to be implemented by one power supply device 20.

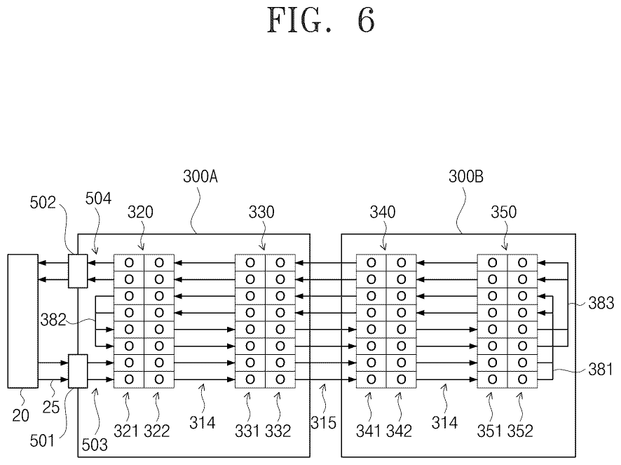

FIG. 6 is a diagram schematically illustrating a structure in which a power supply device circulates a current through a power feeding cable in another exemplary embodiment of FIG. 5.

Referring to FIG. 6, a first terminal unit 320 and a second terminal unit 330 may be provided to the first transfer chamber 300A. A third terminal unit 340 and a fourth terminal unit 350 may be provided to the second transfer chamber 300B.

A supply cable 503, a return cable 504, and a second connection member 382 may be connected to the first terminal unit 320. The first and second terminal units 320 and 330 may be connected by the power feeding cable 314.

The first connection member 381 and the third connection member 383 may be connected to the fourth terminal unit 350. The third and fourth terminal units 340 and 350 may be connected by the power feeding cable 314.

The first terminal unit 320 may be provided as a front terminal unit. The fourth terminal unit 350 may be provided as a rear terminal unit.

The second and third terminal units 330 and 340 positioned between the first and fourth terminal units 320 and 350 may be provided as connection terminal units. A connection cable 315 may be connected between the connection terminal units. One end of the connection cable 315 may be disposed in the first transfer chamber 300A, and the other end of the connection cable 315 may be disposed in the second transfer chamber 300B. Since the current flow is similar to that of FIG. 4, repeated descriptions thereof will be omitted.

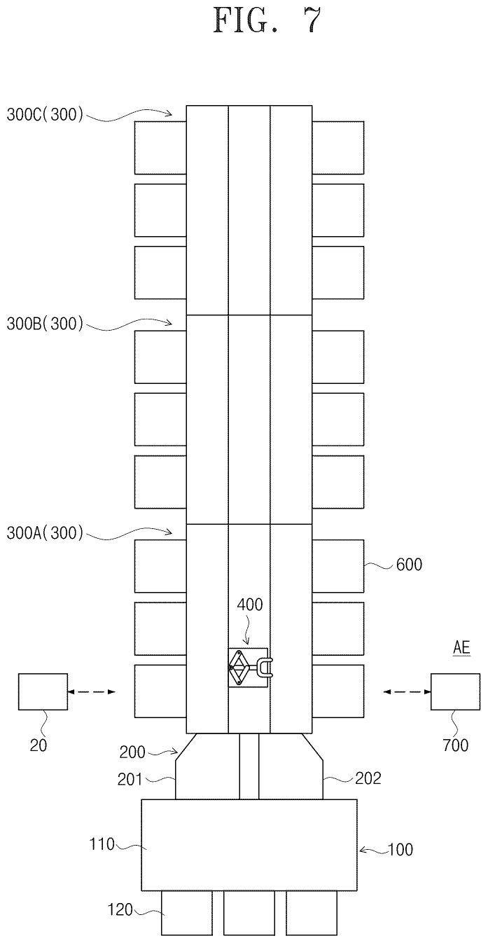

In the above-mentioned example, the present invention has been described based on the case where two transfer chambers 300 are provided as an example, but as illustrated in FIG. 7, three transfer chambers 300 may be provided. For example, a plurality of transfer chambers 300 may include a first transfer chamber 300A, a second transfer chamber 300B, and a third transfer chamber 300C. The power supply structure may be similar to the above-described example.

In the above-described example, the present invention has been described based on the case where when the power supply structure is expanded, the transfer chamber 300 itself is additionally connected as an example, but the present invention is not limited thereto.

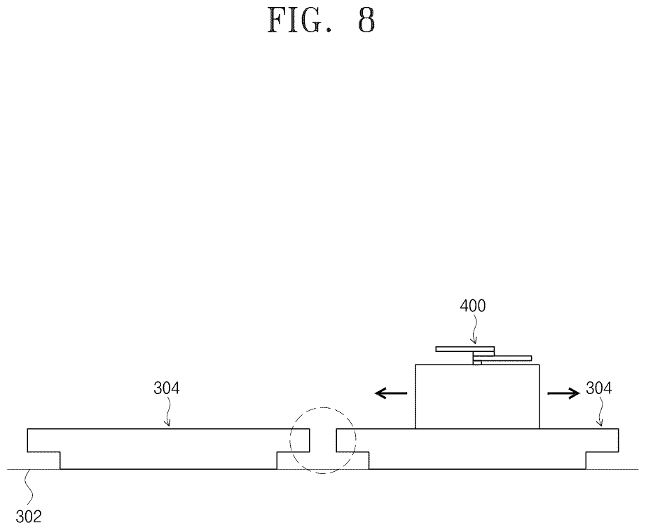

For example, a plurality of base plates 304 may be provided on the chamber base 302 of one transfer chamber 300 as illustrated in FIG. 8. Two terminal units may be provided on one base plate 304, and the two terminal units may be connected to each other by the power feeding cable 314. Furthermore, the travelling rail 303 described above may be provided on each base plate 304. That is, the user may connect as many base plates 304 provided in the form of modules as needed in order to adjust the driving length of the transfer robot 400 within one transfer chamber 300.

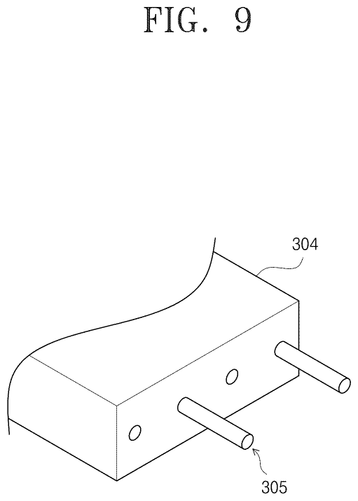

Additionally, when the plurality of base plates 304 is connected, an aligning unit 305 as illustrated in FIG. 9 may be provided at the end of the base plate 304 so that the base plates 304 may be aligned with each other. The aligning unit 305 may be provided in an uneven structure, but the present invention is not limited thereto, and the aligning unit 305 may be modified in various forms by which the positions of the base plates 304 may be aligned when the base plates 304 are connected to each other.

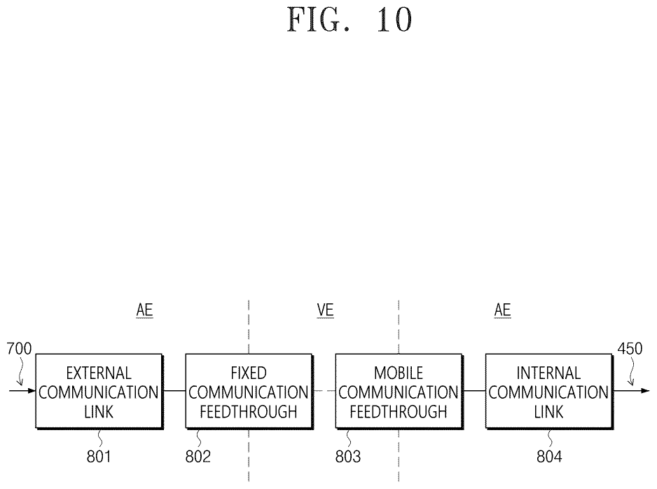

FIG. 10 is a diagram illustrating a communication method between an external controller located outside a transfer chamber of FIG. 1 and a robot controller located inside the transfer chamber.

Referring to FIG. 10, the external controller 700 may be communicatively connected to the robot controller 450 which may be provided in the enclosure 410 of the transfer robot 400. Accordingly, the control signal of the external controller 700 may be transmitted to the robot controller 450. The external controller 700 provided to the atmospheric pressure atmosphere AE may include a communication means, such as a LAN card, and the external communication link 801 of the external controller 700 may be coupled to a fixed communication feedthrough 802 which may be provided to the transfer chamber 300. The fixed communication feedthrough 802 may be located at an interface between the external atmospheric pressure atmosphere AE and the vacuum atmosphere VE inside the transfer chamber 300. The fixed communication feedthrough 802 may be communicatively connected to the mobile communication feedthrough 803. The mobile communication feedthrough 803 may be provided in the transfer robot 400 and may be linearly moved together with the transfer robot 400.

The mobile communication feedthrough 803 may be located at the interface between the space of the atmospheric pressure atmosphere AE provided by the enclosure 410 and the vacuum atmosphere VE inside the transfer chamber 300. The mobile communication feedthrough 803 may be coupled to the internal communication link 804 of the robot controller 450.

In the process of transmitting the control signal of the external controller 700 to the robot controller 450, the control signal needs to sequentially pass the atmospheric pressure atmosphere AE, the vacuum atmosphere VE, and the atmospheric pressure atmosphere AE. In this case, communication connection may not be smooth. However, in the exemplary embodiment of the present invention, since the fixed communication feedthrough 802 and the mobile communication feedthrough 803 are located at the interface between the atmospheric pressure atmosphere AE and the vacuum atmosphere VE, respectively, the above-described communication connection may be smoothly performed.

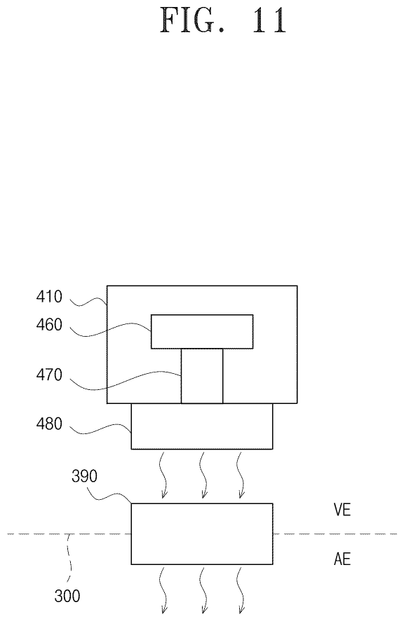

FIG. 11 is a diagram illustrating a heat dissipation method for discharging heat generated by an active device located in the transfer robot of FIG. 1 to the outside.

As described above, various active components 460 may be provided in the enclosure 410 of the transfer robot 400. The active components 460 may be the actuators described above, the robot controller 450 described above, and/or various components provided to operate the transfer robot 400. The active components 460 may be components that operate by receiving power. Therefore, the active components 460 may generate heat. The inner space provided by the enclosure 410 may be provided in a sealed form with respect to the inner atmosphere of the transfer chamber 300. In order to maintain the airtightness, the enclosure 410 may be provided with sealing means, such as an O-ring. Accordingly, heat generated by the active component 460 may be difficult to be discharged to the outside from the inner space of the enclosure 410.

Therefore, the exemplary embodiment of the present invention may further include a heat pump 470, a movable heat dissipation member 480, and a fixed heat dissipation member 390.

The heat pump 470 may be provided in the enclosure 410 to transfer heat from the active component 460 to the movable heat dissipation member 380. One surface of the movable heat dissipation member 380 may face the inner space of the enclosure 410, and the other surface thereof may face the fixed heat dissipation member 390. The fixed heat dissipation member 390 may be located at the interface between the vacuum atmosphere VE in the transfer chamber 300 and the external atmospheric pressure atmosphere AE. Furthermore, the fixed heat dissipation member 390 may be provided to extend along the travelling rail 303.

That is, the heat of the active component 460 is transferred to the movable heat dissipation member 380 by the heat pump 470, the heat transferred to the movable heat dissipation member 380 is transferred to the fixed heat dissipation member 390, and the heat transferred to the fixed heat dissipation member 390 may be discharged to the outside. Through the heat dissipation structure, the present invention may prevent the internal temperature of the enclosure 410 from being excessively increased.

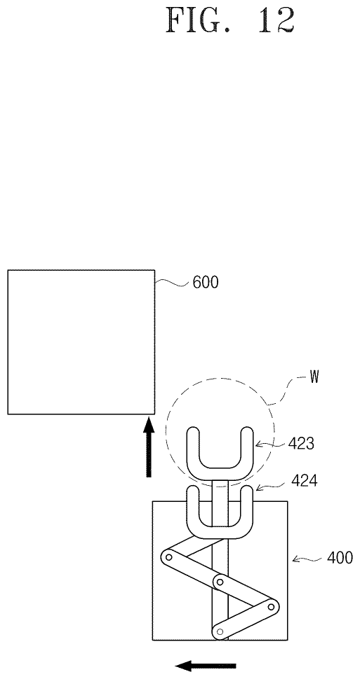

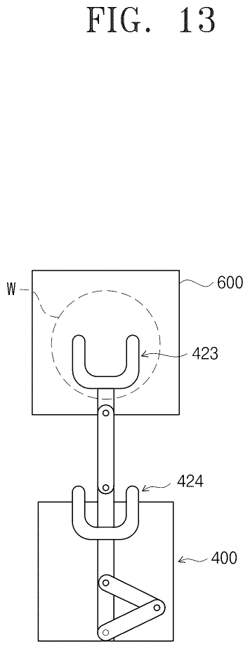

FIGS. 12 and 13 are diagrams illustrating a method of transferring a substrate to the process chamber by the transfer robot of FIG. 1. Referring to FIGS. 12 and 13, in order to shorten a time for transferring the substrate W by the transfer robot 400, a linear movement of the transfer robot 400 and a stretching-contracting operation of the robot arm 420 may be simultaneously performed. For example, the transfer robot 400 may extend-contract the robot arm 420 while the transfer robot linearly moves by the travelling rail 303 and the travelling actuator 440 to load the substrate into the process chamber 600 or unload the substrate W from the process chamber 600.

It should be understood that exemplary embodiments are disclosed herein and that other variations may be possible. Individual elements or features of a particular exemplary embodiment are not generally limited to the particular exemplary embodiment, but are interchangeable and may be used in selected exemplary embodiments, where applicable, even when not specifically illustrated or described. The modifications are not to be considered as departing from the spirit and scope of the present invention, and all such modifications that would be obvious to one of ordinary skill in the art are intended to be included within the scope of the accompanying claims.

1. An apparatus for processing a substrate, the apparatus comprising:
at least one transfer chamber; and
a transfer robot which is linearly movable within the transfer chamber and transfers a substrate,
wherein the transfer robot includes a power receiving unit that receives power,
the transfer chamber includes:
a chamber base; and
a power feeding unit provided on the chamber base and wirelessly transmitting power to the power receiving unit, and
the power feeding unit includes:
a plurality of power feeding cables;
a plurality of terminal units connected to the plurality of power feeding cables; and
at least one connection member connected to at least one of the plurality of terminal units so as to switch a direction of a current flowing in the power feeding cable at least twice or more times.

2. The apparatus of claim 1, wherein the plurality of terminal units includes:
a front terminal unit electrically adjacent to a power supply device; and
a rear terminal unit electrically farther from the power supply device than the front terminal unit,
the front terminal unit includes a plurality of terminals, and
a part of the plurality of terminals of the front terminal unit is connected to a supply cable receiving the current supplied by the power supply device, and another part is connected to the connection member.

3. The apparatus of claim 2, wherein the front terminal unit includes:
a first front terminal unit adjacent to the power supply device; and
a second front terminal unit electrically farther from the power supply device than the first front terminal unit,
the first front terminal unit and the second front terminal unit include the plurality of terminals, and
the terminals included in the first front terminal unit and the terminals included in the second front terminal unit are provided in pairs to be electrically connected to each other.

4. The apparatus of claim 3, wherein the supply cable is connected to a part of the plurality of terminals of the first front terminal unit,
the connections members are connected to another part of the plurality of terminals of the first front terminal unit, and
return cables for returning the current to the power supply device are connected to still another part of the plurality of terminals of the first front terminal unit.

5. The apparatus of claim 4, wherein the plurality of connection members includes:
a first connection member; and
a second connection member,
the first connection member is connected to a terminal of the rear terminal unit to return the current to the front terminal unit when the current supplied from the supply cable flows into the rear terminal unit through the front terminal unit, and
the second connection member is the connection member connected to the first front terminal unit, and is configured to return the current returned by the first connection member to the rear terminal unit again.

6. The apparatus of claim 2, wherein the power supply device is disposed outside the transfer chamber,
a feedthrough is provided in the transfer chamber,
the power supply device and the feedthrough are connected by an external cable, and
the feedthrough and the front terminal unit are connected by the supply cable.

7. The apparatus of claim 1, wherein an atmosphere in the transfer chamber is controlled by a vacuum atmosphere.

8. The apparatus of claim 1, wherein the power feeding cable is disposed on a first ferrite core, and
the power receiving unit includes a second ferrite core having a shape symmetrical to the first ferrite core and facing the first ferrite core.

9. The apparatus of claim 2, wherein the power supply device includes:
a power source; and
a primary-side converter unit connected to the power source, and
the robot includes:
a secondary-side converter unit that converts power received by the power receiving unit; and
an actuator receiving power from the secondary-side converter unit.

10. The apparatus of claim 2, wherein the transfer chamber is provided in plural,
a plurality of connection terminal units is provided between the front terminal unit and the rear terminal unit,
any one of the connection terminal units is provided to one of the plurality of transfer chambers, and
another of the connection terminal units is provided to another of the plurality of transfer chambers.

11. The apparatus of claim 10, wherein the transfer robot is provided to be continuously linearly movable between the plurality of transfer chambers.

12.-17. (cancelled)

18. An apparatus for processing a substrate, the apparatus comprising:
at least one transfer chamber; and
a process chamber; and
a transfer robot which is linearly movable within the transfer chamber and transfers a substrate to the transfer chamber,
wherein the transfer robot includes a power receiving unit that receives power,
the transfer chamber includes:
a chamber base; and
a power feeding unit provided in the chamber base,
the power feeding unit includes:
a plurality of power feeding cables;
a plurality of terminal units connected to one end and the other end of the plurality of power feeding cables,
the plurality of terminal units includes:
a front terminal unit connected with a power supply device; and
a rear terminal unit electrically farther from the power supply device than the front terminal unit,
the front terminal unit includes:
a first front terminal unit electrically adjacent to the power supply device; and
a second front terminal unit electrically farther from the power supply device than the first front terminal unit,
the first front terminal unit and the second front terminal unit include the plurality of terminals, and
the terminals included in the first front terminal unit and the terminals included in the second front terminal unit are provided in pairs to be electrically connected to each other, and
supply cables for supplying the current of the power supply device are connected to a part of the plurality of terminals of the first front terminal unit, and second connection members for returning the current flowing-in from the rear terminal unit into the front terminal unit are connected to another part.

19. The apparatus of claim 18, wherein return cables for returning the current to the power supply device are connected to still another part of the plurality of terminals of the first front terminal unit.

20. The apparatus of claim 18, further comprising:
a first connection member,
wherein the first connection member is connected to a terminal of the rear terminal unit to return the current to the front terminal unit when the current supplied from the supply cable flows into the rear terminal unit through the front terminal unit,
the power supply device is disposed outside the transfer chamber,
a feedthrough is provided in the transfer chamber,
the power supply device and the feedthrough are connected by an external cable, and
the feedthrough and the front terminal unit are connected by the supply cable.
